(19) United States
(12) Patent Application Publication
(10) Pub. No.: US 2026/0004334 A1
(43) Pub. Date: Jan. 1, 2026

(54) SYSTEM AND METHOD FOR RECOMMENDING PRODUCTS

(71) Applicant: JPMorgan Chase Bank, N.A., New York, NY (US)

(72) Inventor: Abhinandan CHAUDHURY, Bengaluru (IN)

(73) Assignee: JPMorgan Chase Bank, N.A., New York, NY (US)

(21) Appl. No.: 19/253,083

(22) Filed: Jun. 27, 2025

(30) Foreign Application Priority Data
Jun. 27, 2024 (IN) 202411049358

(51) Int. Cl. G06Q 30/0601; G06Q 40/02

(52) U.S. Cl. CPC G06Q 30/0631; G06Q 40/02

(57) ABSTRACT

A system and method for recommending products are disclosed. The method includes: receiving financial data associated with an account of a user; analyzing the financial data to determine a residual amount in the account of the user; recommending, using a recommendation engine, at least one product along with an associated confidence score to the user; receiving user feedback that relates to the recommended at least one product; generating a set of tasks associated with the recommended at least one product upon reception of a positive response from the user; and executing, using an action engine, the set of tasks associated with the recommended at least one product.

### CROSS-REFERENCE TO RELATED APPLICATIONS

This application claims priority benefit from Indian Application No. 202411049358, filed on Jun. 27, 2024, in the India Patent Office, which is hereby incorporated by reference in its entirety.

### FIELD OF THE DISCLOSURE

This technology generally relates to providing recommendations of products, and more particularly relates to methods and systems for recommending banking products using a machine learning (ML) based model.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Given the current economic instability, investing in long-term goals such as retirement or other objectives demands a high level of discipline, attention and planning. Financial planning allows individuals to execute investments for long-term goals, enabling them to organize their resources (such as income, expenses) as efficiently as possible. In the realm of finance, numerous tools and approaches are available to help customers understand their financial needs and make informed decisions.

Static data sources and historical trends are the main sources of input for traditional financial planning tools. Although traditional financial planning tools may offer broad guidance and suggestions, they frequently are not able to adapt quickly to changing socioeconomic situations and particular personal preferences. As a result, each customer or user may receive generic financial advice that may not be customized to their specific needs, current economic conditions, and user expense activities.

Nowadays, most users (for example, bank account holders) have access to a variety of banking products for their regular banking needs and investments, such as savings accounts, current accounts, certificates of deposit, fixed deposits, debit and credit cards. For investments, users often select banking products without proper assistance or advice. Furthermore, many times, users make investment decisions based on word of mouth, industry peer discussions, and family discussions. Such investments without proper planning may not be the best fit for users. Moreover, due to a lack of financial knowledge, there is a high possibility that users may select banking products that hamper the growth of their money or returns.

Hence, in view of these and other existing limitations, there arises an imperative need to provide an efficient solution to overcome the above-mentioned limitations and to provide a method and system for recommending banking products to the users based on their income, expenses, and the like.

### SUMMARY

The present disclosure, through one or more of its various aspects, embodiments, and/or specific features or sub-components, provides, inter alias, various systems, servers, devices, methods, media, programs, and platforms for recommending products.

According to an aspect of the present disclosure, a method for recommending products is disclosed. The method is implemented by at least one processor. The method includes receiving, by the at least one processor, financial data associated with an account of a user; analyzing, by the at least one processor, the financial data to determine a residual amount in the account of the user; recommending, by the at least one processor using a recommendation engine, at least one product along with an associated confidence score to the user; receiving, by the at least one processor, user feedback that relates to the recommended at least one product; generating, by the at least one processor, a set of tasks associated with the recommended at least one product upon reception of a positive response from the user; and executing, by the at least one processor using an action engine, the set of tasks associated with the recommended at least one product.

In accordance with an exemplary embodiment, the user feedback may be received as at least one from among a voice-based input, a text-based input, a sign language-based input, and any combination thereof.

In accordance with an exemplary embodiment, the financial data may include income details, expense details, loan details, a transaction history, an existing investment, and utility bills of the user.

In accordance with an exemplary embodiment, the recommending of the at least one product may include the steps of identifying, by the at least one processor, the at least one product based on the residual amount; determining, by the at least one processor using the recommendation engine, the associated confidence score for the at least one product; and recommending, by the at least one processor, the at least one product along with the associated confidence score.

In accordance with an exemplary embodiment, the user feedback that relates to the recommended at least one product may include at least one from among the positive response to accept the recommended at least one product and a negative response to reject the recommended at least one product.

In accordance with an exemplary embodiment, the method may further include obtaining, by the at least one processor, at least one reason for the negative response to reject the recommended at least one product.

In accordance with an exemplary embodiment, the at least one reason for the negative response may be utilized to provide a continuous training to the recommendation engine.

In accordance with an exemplary embodiment, the method may further include ranking, by the at least one processor using the recommendation engine, the at least one product based on the associated confidence score. The method may further include displaying, by the at least one processor, the at least one product along with a result of the ranking.

In accordance with an exemplary embodiment, the recommendation engine may be trained using a machine learning based model.

According to another aspect of the present disclosure, a computing device configured to implement an execution of a method for recommending products is disclosed. The computing device includes a processor; a memory storing instructions; and a communication interface coupled to each of the processor and the memory. The processor is programmed to use the instructions to perform operations that comprise: receiving financial data associated with an account of a user; analyzing the financial data to determine a residual amount in the account of the user; recommending, using a recommendation engine, at least one product along with an associated confidence score to the user; receiving user feedback that relates to the recommended at least one product; generating a set of tasks associated with the recommended at least one product upon reception of a positive response from the user; and executing, using an action engine, the set of tasks associated with the recommended at least one product.

In accordance with an exemplary embodiment, the user feedback may be received as at least one from among a voice-based input, a text-based input, a sign language-based input, and any combination thereof.

In accordance with an exemplary embodiment, the financial data may include income details, expense details, loan details, a transaction history, an existing investment, and utility bills of the user.

In accordance with an exemplary embodiment, the recommending of the at least one product may include identifying the at least one product based on the residual amount; determining, using the recommendation engine, the associated confidence score for the at least one product; and recommending the at least one product along with the associated confidence score.

In accordance with an exemplary embodiment, the user feedback that relates to the recommended at least one product may include at least one from among the positive response to accept the recommended at least one product and a negative response to reject the recommended at least one product.

In accordance with an exemplary embodiment, the processor may be further configured to obtain at least one reason for the negative response to reject the recommended at least one product.

In accordance with an exemplary embodiment, the at least one reason for the negative response may be utilized to provide a continuous training to the recommendation engine.

In accordance with an exemplary embodiment, the processor may be further configured to rank, using the recommendation engine, the at least one product based on the associated confidence score; and display the at least one product along with a result of the ranking.

In accordance with an exemplary embodiment, the recommendation engine may be trained using a machine learning based model.

According to yet another aspect of the present disclosure, a non-transitory computer-readable storage medium storing instructions for recommending products is disclosed. The instructions include executable code which, when executed by a processor, causes the processor to perform operations comprising: receiving financial data associated with an account of a user; analyzing the financial data to determine a residual amount in the account of the user; recommending, using a recommendation engine, at least one product along with an associated confidence score to the user; receiving user feedback that relates to the recommended at least one product; generating a set of tasks associated with the recommended at least one product upon reception of a positive response from the user; and executing, using an action engine, the set of tasks associated with the recommended at least one product.

In accordance with an exemplary embodiment, the user feedback may be received as at least one from among a voice-based input, a text-based input, a sign language-based input, and any combination thereof.

In accordance with an exemplary embodiment, the financial data may include income details, expense details, loan details, a transaction history, an existing investment, and utility bills of the user.

In accordance with an exemplary embodiment, the recommending of the at least one product may include identifying the at least one product based on the residual amount; determining, using the recommendation engine, the associated confidence score for the at least one product; and recommending the at least one product along with the associated confidence score.

In accordance with an exemplary embodiment, the user feedback that relates to the recommended at least one product may include one of the positive response to accept the recommended at least one product and a negative response to reject the recommended at least one product.

In accordance with an exemplary embodiment, operations may further include obtaining at least one reason for the negative response to reject the recommended at least one product.

In accordance with an exemplary embodiment, the at least one reason for the negative response may be utilized to provide a continuous training to the recommendation engine.

In accordance with an exemplary embodiment, the operations may further include: ranking, using the recommendation engine, the at least one product based on the associated confidence score; and displaying the at least one product along with a result of the ranking.

In accordance with an exemplary embodiment, the recommendation engine may be trained using a machine learning based model.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for recommending products, in accordance with an exemplary embodiment of the present disclosure.

FIG. 2 illustrates an exemplary diagram of a network environment for recommending products, in accordance with an exemplary embodiment of the present disclosure.

FIG. 3 illustrates an exemplary system for recommending products, in accordance with an exemplary embodiment of the present disclosure.

FIG. 4 illustrates an exemplary method flow diagram for recommending products, in accordance with an exemplary embodiment of the present disclosure.

FIG. 5 illustrates a process flow diagram usable for recommending products, in accordance with an exemplary embodiment of the present disclosure.

FIG. 6 illustrates an exemplary system flow diagram of a recommendation engine for recommending products, in accordance with an embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for recommending products. More particularly, the present disclosure provides the method and system for recommending banking products to a user based on an analysis of the user's financial data. Initially, the system receives the financial data associated with an account of the user. The system further analyzes the financial data to determine a residual amount in the account of the user. In an example, the system analyses the income details, expense details, current policies, loan details, and due dates associated with the payment of equated monthly installments (EMIs). The system further utilizes a recommendation engine to recommend at least one product along with an associated confidence score to the user. Next, the system receives user feedback that relates to the recommended at least one product to further train the recommendation engine for better recommendation of the at least one product. The system further generates a set of tasks associated with the recommended at least one product upon reception of a positive response from the user. The system further executes, using an action engine, the set of tasks associated with the recommended at least one product. If the user provides a negative response regarding the recommended at least one product, then the system further asks the user to provide reasons associated with the negative response. The reasons provided by the user are then utilized to further train the system for improvement of subsequent recommendations.

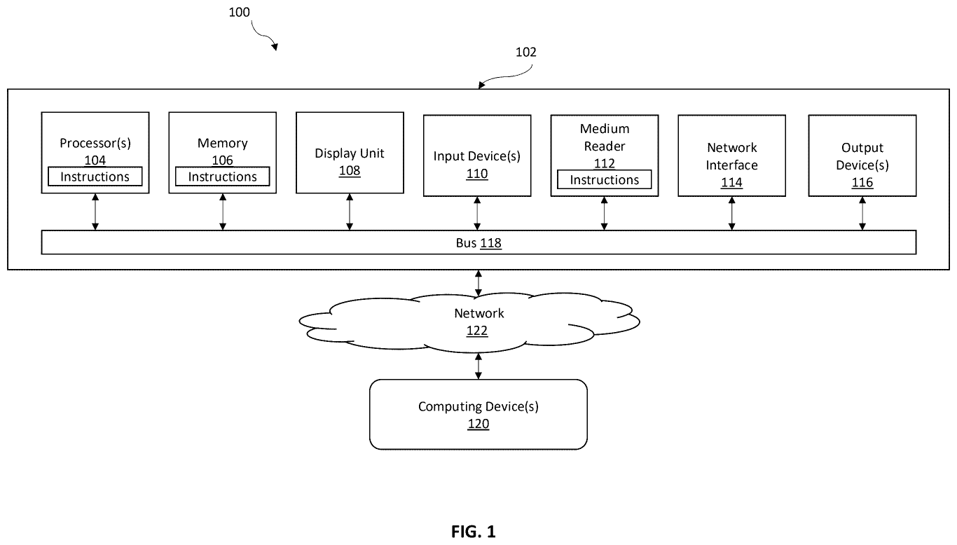

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specification.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, and unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specification.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for recommending products.

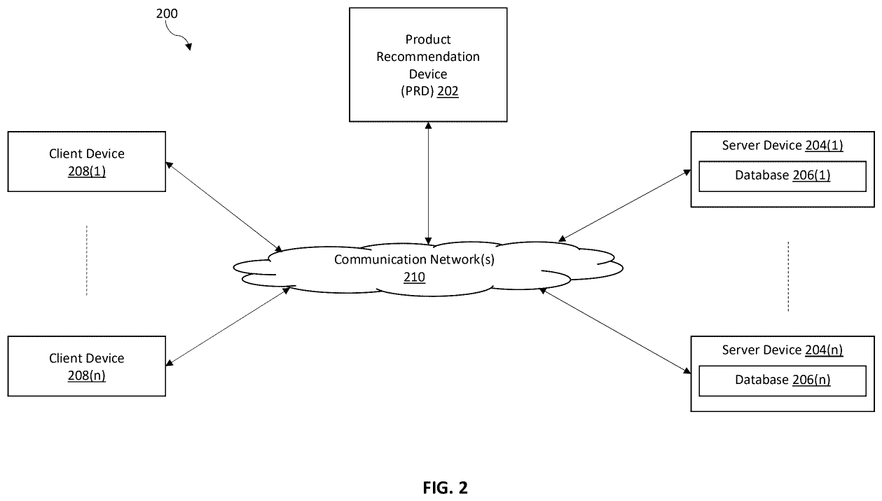

Referring to FIG. 2, a schematic of an exemplary network environment 200 for implementing a method for recommending products is illustrated. In an exemplary embodiment, the method is executable on any networked computer platform, such as, for example, a personal computer (PC).

The method for recommending products may be implemented by a product recommendation device (PRD) 202. The PRD 202 may be the same or similar to the computer system 102 as described with respect to FIG. 1. The PRD 202 may store one or more applications that can include executable instructions that, when executed by the PRD 202, cause the PRD 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting embodiment, the application(s) may be operative in a cloud-based computing environment. The application(s) may be executed within or as a virtual machine(s) or virtual server(s) that may be managed in a cloud-based computing environment. Also, the application(s), and even the PRD 202 itself, may be located in the virtual server(s) running in a cloud-based computing environment rather than being tied to one or more specific physical network computing devices. Also, the application(s) may be running in one or more virtual machines (VMs) executing on the PRD 202. Additionally, in one or more embodiments of this technology, virtual machine(s) running on the PRD 202 may be managed or supervised by a hypervisor.

In the network environment 200 of FIG. 2, the PRD 202 is coupled to a plurality of server devices 204(1)-204(n) that hosts a plurality of databases 206(1)-206(n), and also to a plurality of client devices 208(1)-208(n) via communication network(s) 210. A communication interface of the PRD 202, such as the network interface 114 of the computer system 102 of FIG. 1, operatively couples and communicates between the PRD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PRD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and PRDs that efficiently implement the method for recommending products.

By way of example only, the communication network(s) 210 may include local area network(s) (LAN(s)) or wide area network(s) (WAN(s)), and may use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The PRD 202 may be a standalone device or integrated with one or more other devices or apparatuses, such as one or more of the server devices 204(1)-204(n), for example. In one particular example, the PRD 202 may include or be hosted by one of the server devices 204(1)-204(n), and other arrangements are also possible. Moreover, one or more of the devices of the PRD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the PRD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data required for the implementation of the features of the present disclosure. For instance, the server devices 204(1)-204(n) hosts the databases or repositories 206(1)-206(n) that are configured to store data related to recommendations of at least one product, financial data, and user feedback data on the recommendations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the PRD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the PRD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the PRD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PRD 202, the server devices 204(1)-204(n), or the client devices 208(1)-208(n), for example, may be configured to operate as virtual instances on the same physical machine. In other words, one or more of the PRD 202, the server devices 204(1)-204(n), or the client devices 208(1)-208(n) may operate on the same physical device rather than as separate devices communicating through communication network(s) 210. Additionally, there may be more or fewer PRDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

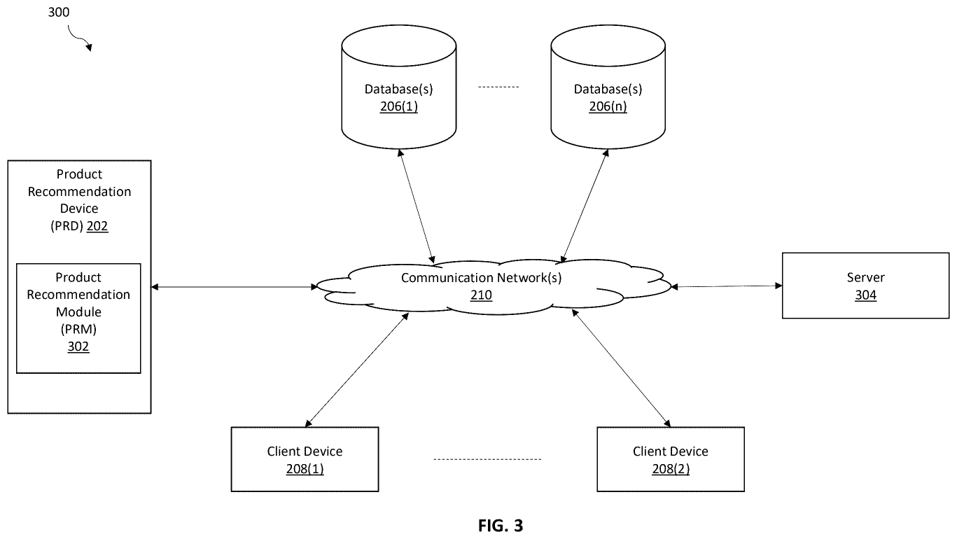

FIG. 3 illustrates a system diagram for implementing a method for recommending products, in accordance with an exemplary embodiment.

As illustrated in FIG. 3, the system 300 may include an PRD 202 within which a product recommendation module (PRM) 302 is embedded, a server 304, a database(s) 206(1) . . . 206(n), a plurality of client devices 208(1) . . . 208(2), and a communication network(s) 210.

According to exemplary embodiments, the PRD 202 including the PRM 302 may be connected to the server 304, and the database(s) 206(1) . . . 206(n) via the communication network(s) 210, but the disclosure is not limited thereto. The PRD 202 may also be connected to the plurality of client devices 208(1) . . . 208(2) via the communication network 210, but the disclosure is not limited thereto. The database(s) 206(1) . . . 206(n) may include a rule database.

In an embodiment, the PRD 202 is described and shown in FIG. 3 as including the PRM 302, although it may include other rules, policies, modules, databases, or applications, for example. As will be described below, the PRM 302 is configured to implement a method for recommending products.

An exemplary system 300 for implementing a mechanism for recommending products by utilizing the network environment of FIG. 2 is shown as being executed in FIG. 3. Specifically, a first client device 208(1) and a second client device 208(2) are illustrated as being in communication with the PRD 202. In this regard, the first client device 208(1) and the second client device 208(2) may be “clients” of the PRD 202 and are described herein as such. Nevertheless, it is to be known and understood that the first client device 208(1) and/or the second client device 208(2) need not necessarily be “clients” of the PRD 202, or any entity described in association therewith herein. Any additional or alternative relationship may exist between either or both of the first client device 208(1) and the second client device 208(2) and the PRD 202, or no relationship may exist.

Further, the PRD 202 is illustrated as being able to access one or more databases 206(1) . . . 206(n). The PRM 302 may be configured to access these repositories/databases for implementing the method for recommending products. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein

The process may be executed via the communication network(s) 210, which may comprise plural networks as described above. For example, in an exemplary embodiment, either or both the first client device 208(1) and the second client device 208(2) may communicate with the PRD 202 via broadband or cellular communication. These embodiments are merely exemplary and are not limiting or exhaustive.

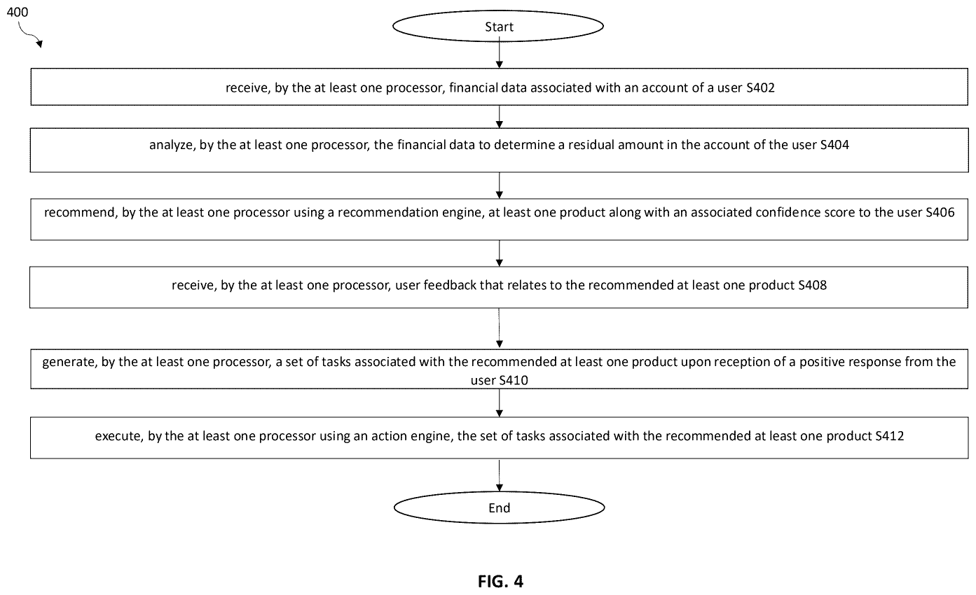

Referring to FIG. 4, an exemplary method 400 is shown for recommending products, in accordance with an exemplary embodiment. As shown in FIG. 4, the method 400 begins following a need for the recommendation of at least one product for financial planning. The method 400 is implemented by at least one processor 104.

At step S402, the method 400 includes receiving, by the at least one processor 104, financial data associated with an account of the user.

The term “financial data” herein may correspond to quantitative information associated with the bank account of the user. The financial data may include at least one from among income details, expense details, loan details, a transaction history, an existing investment, and utility bills of the user. In an exemplary implementation, the account of the user is associated with a financial institution (such as a bank). The term “products” herein may correspond to banking products that benefit the user in maximizing gain using the amount left in the account of the user after paying all expenses and debts. The products may include, but are not limited to, flexi-fixed deposits, a saving account, and a recurring deposit.

The method 400 includes receiving, by the at least one processor 104, the financial data from a database or server of the financial institution. In an exemplary implementation, the financial data may be received from the database or server of the financial institution using a secure mechanism and based on the permission granted by the user to access the financial data. In another exemplary implementation, the method 400 for receiving the financial data may include scanning and/or processing of electronic documents received from the database or server of the financial institution, such as bank statements, the transaction history, utility bills, existing investments, and existing loans.

In an exemplary implementation, the method 400 for receiving the financial data may include importing data from external financial management software or platforms used by the user. In an exemplary implementation, the method 400 includes fetching, by the at least one processor 104, the financial data from at least one external source. The at least one external source may include database(s) or servers of financial institutions (e.g., banks) and the like. The financial data may be fetched using secure data communication protocols to ensure the integrity and confidentiality of the financial data.

At step S404, the method 400 includes analyzing, by the at least one processor 104, the financial data to determine a residual amount in the account of the user.

The term “residual amount” herein may correspond to the amount left over in the account of the user after deducting all expenses or payments from a particular sum of money.

In an exemplary implementation, the residual amount is determined based on an analysis of the financial data of the user such as bank statements, income details, expense details, a loan repayment, shopping, grocery, utility bills, user's expenses, a user transaction history, and the like.

In an exemplary implementation, the financial data may be analyzed in a predefined time interval. The predefined time interval may include time intervals such as daily, weekly, monthly, quarterly, yearly, and the like.

In an exemplary implementation, the method 400 includes providing, by the at least one processor 104, an option for the user to modify the determined residual amount as per the preference of the user. The option may be provided via a user interface (UI) of the financial institution. The user may use the UI rendered on a display unit of a user device (for example, via the UI) to modify the residual amount. The user may also provide comments or reasons for modifying the residual amount.

At step S406, the method 400 includes recommending, by the at least one processor 104 using a recommendation engine, at least one product along with an associated confidence score to the user.

The term “confidence score” herein may correspond to a score that provides a probability of yield increase for a particular banking product or combination of banking products recommended by the recommendation engine.

For example, the at least one product may include one from among a saving account, a current account, a certificate of deposit, a fixed deposit, a recurring deposit, bonds, equities, exchange-traded funds (ETFs), stocks, gold funds, government securities, and the like.

The recommendation engine may provide recommendations that include but are not limited to, the at least one product, a list of products, or a combination of products along with their associated confidence score(s) via the UI. The user may then select the preferred product(s) or the combination of products from the recommended products. The recommendations may include a display of the list of products, and an investment period for the at least one product.

To recommend the at least one product, the method 400 includes steps of identifying, by the at least one processor 104, the at least one product based on the residual amount. Further, the method 400 includes determining, by the at least one processor 104 using the recommendation engine, the associated confidence score for the at least one product. Further, the method 400 includes recommending, by the at least one processor 104, the at least one product along with the associated confidence score.

Further, the method 400 includes ranking, by the at least one processor 104 using the recommendation engine, the at least one product based on their corresponding confidence score. The method 400 includes displaying, by the at least one processor 104, the at least one product along with their confidence rank.

The recommended products provided by the recommendation engine are ranked based on the confidence scores, allowing the user via the UI to see the most relevant options from the recommended products.

In an exemplary implementation, the recommendation engine is trained using a machine learning based model. More particularly, the recommendation engine is trained using a recurrent neural network (RNN) technique, which facilitates recommendation of the at least one product efficiently and reliably and further facilitates error propagation through previous layers, enabling continuous learning from mistakes and ongoing improvement in accuracy. The training of the recommendation engine is performed using a set of data associated with products, past recommendations of products, socio-economic factors, and the like. Further, the training of the recommendation engine is also based on the user feedback received on the recommended at least one product.

The recommendation engine employed by the at least one processor 104 in step S406 may use various artificial intelligence (AI) or machine learning (ML) algorithms to recommend the at least one product. The recommendation engine may utilize both the financial data and the user's preferences, to recommend the at least one product that may offer high returns to the user. The recommendation engine may consider various economic indicators like inflation rates, interest rates, and the like, along with user-selected preferences. The recommendation engine may consider various economic indicators like inflation rates, interest rates, and the like, along with user-selected preferences to advise the product or combination of products with amounts which may yield high benefit to the user.

In an exemplary implementation, the method 400 includes rendering, by the at least one processor 104 via the UI of the display unit, the recommendation of the at least one product along with the associated confidence score.

Furthermore, the method 400 includes transmitting, by the at least one processor 104 via the UI, a notification to the user device of the user to alert the user about the recommendation of the at least one product. The notification may be customized to be delivered via various channels, such as email, short message service (SMS), or even as a push notification from an application, depending on the system's capabilities and the user's preferences.

At step S408, the method 400 includes receiving, by the at least one processor 104, user feedback that relates to the recommended at least one product. The method includes receiving, by the at least one processor 104, the user feedback responsive to the recommendation of the at least one product. The recommendation of the at least one product is rendered on the UI for user review and approval.

The user feedback is received as at least one from among a voice-based input, a text-based input, a sign language-based input, and any combination thereof. The recommendation of the at least one product includes but is not limited to, the recommendation of the list of products along with their confidence scores, the recommendation of a product or combination of products, and the recommendation of an investment period for the recommended at least one product. In this way, the method 400 intelligently recommends the best suited product or combination of products by determining different factors both by user input (voice based, text based, sign based (video) for persons with disabilities as well as for others) and derived behavioral factors from the previous outcomes for different banking products, and provides a confidence score to support its recommendation.

In an exemplary implementation, the method 400 may include receiving, by the at least one processor 104, a positive response from the user to accept the recommended at least one product. The positive response corresponds to the acceptance of the recommended at least one product by the user, thereby enabling the user to take an intelligent decision to choose the recommended product or a combination of products with no or minimal human intervention.

The method 400 may further include receiving, by the at least one processor 104, a negative response from the user to reject the recommended at least one product. In an exemplary implementation, the method includes querying, by the at least one processor 104, a user to fill a feedback form to mention at least one reason associated with the negative response of the user on the recommended at least one product. Upon receiving the user feedback, the method further includes analyzing, by the at least one processor 104, the user feedback to identify user behavioral patterns towards the recommended at least one product. The feedback of the user may be used for further training of the recommendation engine so that the user may receive better recommendations in the future considering the user feedback and preferences of the user. Further, the user feedback ensures that the recommendation engine becomes increasingly accurate and tailored to the user's specific needs and preferences over time.

Additionally, the feedback of the user allows the recommendation engine to adapt to changes based on the user's behavior or circumstances. Further, the updating of the recommendation engine adds a layer of adaptability to the system. By continuously learning from the user's feedback, the recommendation engine ensures that the recommendations are relevant, thereby enhancing the utility and effectiveness of the overall product recommendation system.

It will be appreciated by the person skilled in the art that the aim here is to create a more dynamic and responsive product recommendation system. By considering both micro-level data like individual preferences (for example, user preferences) and the financial data, the system may adapt to a wide variety of conditions and offer recommendations of products that are both personalized and robustly informed.

At step S410, the method 400 includes generating, by the at least one processor 104, a set of tasks associated with the recommended at least one product upon reception of the positive response from the user. Upon acceptance of the recommended at least one product by the user via the UI, the method includes the step of generating the set of tasks related to the investment of the recommended at least one product. The set of tasks may be arranged in a predefined manner for the successful execution of an investment in the recommended at least one product. The set of tasks may include automated tasks that execute investment in the recommended at least one product.

At step S412, the method 400 includes executing, by the at least one processor 104 using an action engine, the set of tasks associated with the recommended at least one product. The method 400 includes causing the action engine to execute the set of tasks associated with the recommended at least one product for investing the residual amount into the recommended at least one product. This way the disclosed method 400 allows the user to choose the right product for different types of personalized behavior and helps execute investments for the residual amount into the recommended products and ensures growth of the residual amount.

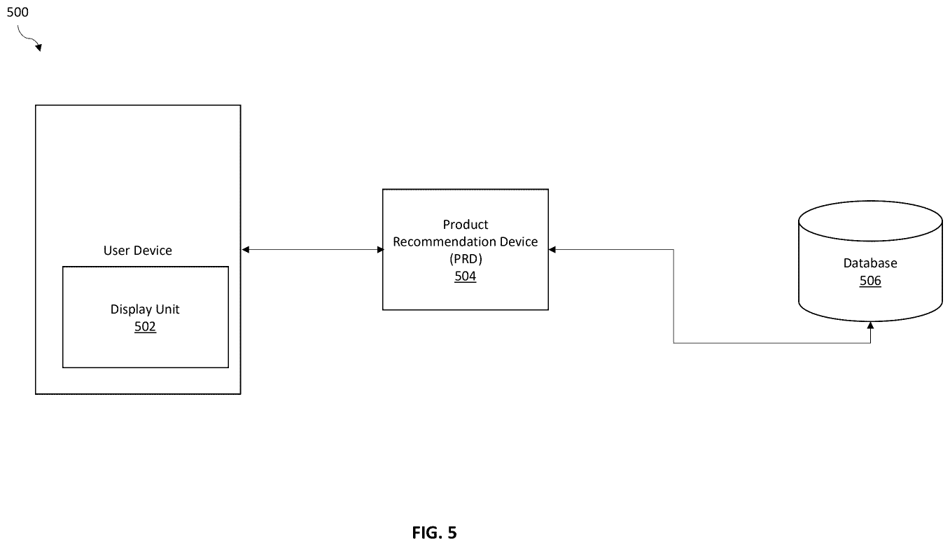

FIG. 5 illustrates a process flow diagram usable for recommending products, in accordance with an exemplary embodiment. As illustrated in FIG. 5, the process flow 500 begins with receiving, by a product recommendation device (PRD) 504, financial data associated with an account of a user. The financial data includes but is not limited to, income details, expense details, loan details, a transaction history, an existing investment, and utility bills of the user. In an exemplary implementation, the PRD 504 may fetch the financial data from external sources, including, for example, a database 506 associated with financial institutions.

The PRD 504 further analyzes the financial data to determine a residual amount and recommends, using the recommendation engine, at least one product along with an associated confidence score to the user. The PRD 504 may recommend a list of products, or a combination of products to the user based on the residual amount. The PRD 504 is further configured to rank the at least one product based on their corresponding confidence score and display the at least one product along with their corresponding score and rank via a user interface (UI) rendered on a display unit 502 of a user device. The PRD 504 further receives user feedback on the recommended at least one product and generates a set of tasks for the recommended at least one product upon reception of a positive response from the user. Finally, the PRD 504 executes, using the action engine, the set of tasks associated with the recommended at least one product for investing the residual amount into the recommended at least one product. Hence, the PRD 504 ensures growth of the residual amount.

Further, any user feedback received through the UI is used to update the recommendation engine. For instance, reasons and comments may be received from the user in case the user rejects a recommendation of the at least one product. Thus, the feedback may be utilized to further train the PRD 504 to provide better recommendations to the user in the future. This makes the system adaptive and improves its decision-making capabilities over time. It will be appreciated by the person skilled in the art that the PRD 504 offers a full-circle, adaptable, and intelligent solution for recommending products.

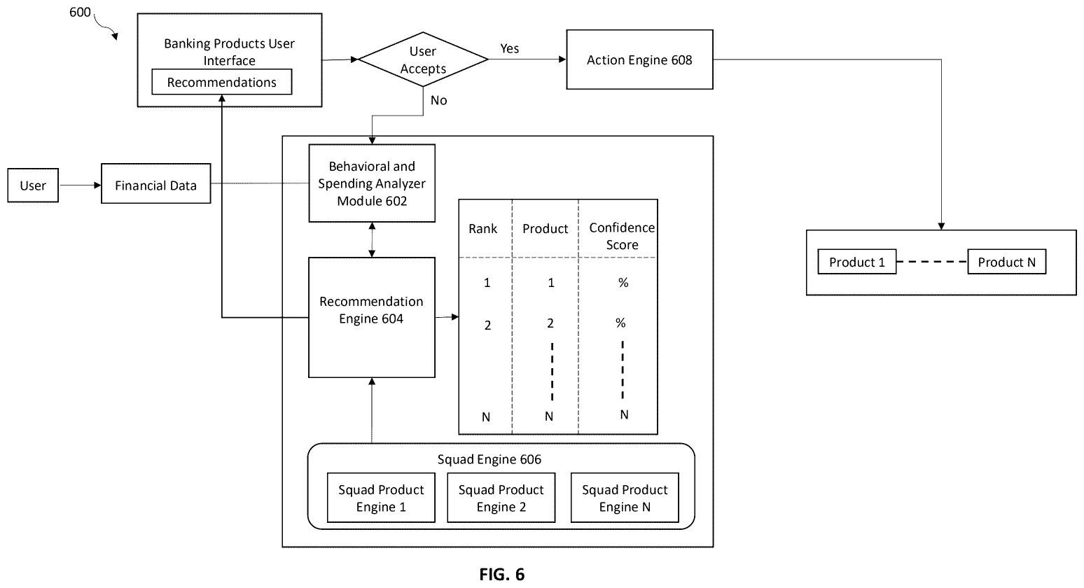

FIG. 6 illustrates an exemplary system flow diagram of a recommendation engine for recommending products, in accordance with an embodiment of the present disclosure. As illustrated in FIG. 6, the system flow 600 begins with receiving a user input via a user interface (UI) (for example, banking platform user interface) for authorizing a user. The user input may include login credentials. The login credentials may include a password, a name of the user, and an email identifier (id). Further, a recommendation engine 604 first asks the user to provide consent for accessing the user data for the recommendation. Once the user provides the consent, the system fetches a financial data of the user for the recommendation. In an exemplary implementation, a behavioral and spending analyzer module 602 fetches the financial data, analyzes the spending habits of the user, and groups them into various categories like a loan repayment category, a shopping category, a grocery category, an amusement category, utility bills category, and the like.

Further, the system is configured to analyze the financial data using the behavioral and spending analyzer module 602 to determine a residual amount in an account of the user. Based on the residual amount, the system 600 utilizes a squad engine 606 to provide recommendations of products to the user. The squad engine 606 corresponds to a rule engine of each product with its rule therein. The squad engine 606 is configured to create a squad of various products with predefined rules to recommend the at least one product. Further, the recommendation engine 604 is configured to determine at least one product (e.g., product 1, product 2 . . . product N), corresponding rank (e.g., rank 1, rank 2 . . . , rank N), and corresponding confidence score (e.g., % of return or growth rate). The rank of the at least one product is determined based on the corresponding confidence score of the at least one product. Thus, the recommendation engine 604 recommends at least one product along with an associated rank and confidence score to the user. Further, the system receives user feedback that relates to the recommended at least one product via the UI. The user feedback that relates to the recommended at least one product includes one of a positive response to accept the recommended at least one product and a negative response to reject the recommended at least one product. The behavioral and spending analyzer module 602 is configured to obtain at least one reason for the negative response regarding the recommended at least one product and is further utilized to provide continuous training to the recommendation engine 604. The at least one reason, received from the user, is fed into the recommendation engine 604 to further train the recommendation engine and to improve the recommendations of at least one product for the user.

Further, the system is configured to create a set of tasks associated with the recommended at least one product upon reception of the positive response from the user. Thereafter, the system, using an action engine, 608 executes the set of tasks associated with the recommended at least one product.

For example, recommendations by the recommendation engine may be provided as follows: a fixed deposit as product 1, a recurring deposit as product 2, and a bond as product 3 for an investment period such as several days, a week or two weeks, a month or quarter. In an exemplary implementation, if the user chooses yes for the recommended product selection with amount, then action engine 608 takes the action and makes the investment in that product or combination of products. If the user chooses not to go by the recommended product or combination of products, then the user needs to site the reason for doing so which becomes an input to the behavioral and spending analyzer module 602.

In another exemplary implementation, each section of the recommendations rendered on the UI may include an interactive icon. When the user clicks on these icons, a tooltip might appear, providing more context or rationale behind each of the recommended products. Further, the UI also incorporates interactive features that allow the user to make quick edits or flag sections for later review. These interactive capabilities serve as the foundation for potential refinement of the recommendation of the at least one product, as the user could immediately respond with their input or comments.

The present disclosure provides several advantages as given below. The present disclosure provides a guided and recommended product selection by analyzing the account holder's behavior and spending habits. The present disclosure highlights the benefits of potential earning over a short term horizon as well as over a long term horizon. The present method and system work based on analytical wisdom rather than personal biases, thereby providing benefits to the user from analytics based, historical decision based analyzed recommended product or combination of products without losing the control of human wisdom. The present disclosure provides customized recommendations on banking products to the user for increasing the wealth of the user by utilizing the residual amount. Further, the present disclosure automates investments for the recommended banking products upon receiving a positive response from the user. The present disclosure also provides a user-friendly interface that displays recommended products along with their ranks and confidence score. The present disclosure provides a scalable system architecture that can handle increasing volumes of data and user interactions and further utilizes cloud-based solutions to ensure the system can expand seamlessly as demand grows.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for recommending products is disclosed. The instructions include executable code which, when executed by a processor, may cause the processor to receive financial data associated with an account of a user; analyze the financial data to determine a residual amount in the account of the user; recommend, using a recommendation engine, at least one product along with an associated confidence score to the user; receive user feedback that relates to the recommended at least one product; generate a set of tasks associated with the recommended at least one product upon reception of a positive response from the user; and execute, using an action engine, the set of tasks associated with the recommended at least one product.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for recommending products, the method being implemented by at least one processor, the method comprising:
receiving, by the at least one processor, financial data associated with an account of a user;
analyzing, by the at least one processor, the financial data to determine a residual amount in the account of the user;
recommending, by the at least one processor using a recommendation engine, at least one product along with an associated confidence score to the user;
receiving, by the at least one processor, user feedback that relates to the recommended at least one product;
generating, by the at least one processor, a set of tasks associated with the recommended at least one product upon reception of a positive response from the user; and
executing, by the at least one processor using an action engine, the set of tasks associated with the recommended at least one product.

2. The method as claimed in claim 1, wherein the user feedback is received as at least one from among a voice-based input, a text-based input, a sign language-based input, and any combination thereof.

3. The method as claimed in claim 1, wherein the financial data comprises income details, expense details, loan details, a transaction history, an existing investment, and utility bills of the user.

4. The method as claimed in claim 1, wherein the recommending of the at least one product comprises:
identifying, by the at least one processor, the at least one product based on the residual amount;
determining, by the at least one processor using the recommendation engine, the associated confidence score for the at least one product; and
recommending, by the at least one processor, the at least one product along with the associated confidence score.

5. The method as claimed in claim 1, wherein the user feedback that relates to the recommended at least one product comprises at least one from among the positive response to accept the recommended at least one product and a negative response to reject the recommended at least one product.

6. The method as claimed in claim 5, further comprising:
obtaining, by the at least one processor, at least one reason for the negative response to reject the recommended at least one product.

7. The method as claimed in claim 6, wherein the at least one reason for the negative response is utilized to provide a continuous training to the recommendation engine.

8. The method as claimed in claim 1, further comprising:
ranking, by the at least one processor using the recommendation engine, the at least one product based on the associated confidence score; and
displaying, by the at least one processor, the at least one product with a result of the ranking.

9. The method as claimed in claim 1, wherein the recommendation engine is trained using a machine learning based model.

10. A computing device configured to implement an execution of a method for recommending products, the computing device comprising:
a processor;
a memory storing instructions; and
a communication interface coupled to each of the processor and the memory,
wherein the processor is programmed to use the instructions to perform operations comprising:
receiving financial data associated with an account of a user;
analyzing the financial data to determine a residual amount in the account of the user;
recommending, using a recommendation engine, at least one product along with an associated confidence score to the user;
receiving user feedback that relates to the recommended at least one product;
generating a set of tasks associated with the recommended at least one product upon reception of a positive response from the user; and
executing, using an action engine, the set of tasks associated with the recommended at least one product.

11. The computing device as claimed in claim 10, wherein the user feedback is received as at least one from among a voice-based input, a text-based input, a sign language-based input, and any combination thereof.

12. The computing device as claimed in claim 10, wherein the financial data comprises income details, expense details, loan details, a transaction history, an existing investment, and utility bills of the user.

13. The computing device as claimed in claim 10, wherein the recommending of the at least one product comprises:
identifying the at least one product based on the residual amount;
determining, using the recommendation engine, the associated confidence score for the at least one product; and
recommending the at least one product along with the associated confidence score.

14. The computing device as claimed in claim 10, wherein the user feedback that relates to the recommended at least one product comprises at least one from among the positive response to accept the recommended at least one product and a negative response to reject the recommended at least one product.

15. The computing device as claimed in claim 14, wherein the operations further comprise obtaining at least one reason for the negative response to reject the recommended at least one product.

16. The computing device as claimed in claim 15, wherein the at least one reason for the negative response is utilized to provide a continuous training to the recommendation engine.

17. The computing device as claimed in claim 10, wherein the operations further comprise:
ranking, using the recommendation engine, the at least one product based on the associated confidence score; and
displaying the at least one product along with a result of the ranking.

18. The computing device as claimed in claim 10, wherein the recommendation engine is trained using a machine learning based model.

19. A non-transitory computer readable storage medium storing instructions for recommending products, the instructions comprising executable code which, when executed by a processor, causes the processor to perform operations comprising:
receiving financial data associated with an account of a user;
analyzing the financial data to determine a residual amount in the account of the user;
recommending, using a recommendation engine, at least one product along with an associated confidence score to the user;
receiving user feedback that relates to the recommended at least one product;
generating a set of tasks associated with the recommended at least one product upon reception of a positive response from the user; and
executing, using an action engine, the set of tasks associated with the recommended at least one product.

20. The storage medium as claimed in claim 19, wherein the recommending of the at least one product comprises:
identifying the at least one product based on the residual amount;
determining, using the recommendation engine, the associated confidence score for the at least one product; and
recommending the at least one product along with the associated confidence score.
